(19) United States
(12) Patent Application Publication
(10) Pub. No.: US 2007/0294612 A1
(43) Pub. Date: Dec. 20, 2007

(54) Comparing and Managing Multiple Presentations

(75) Inventors: Steven M. Drucker, Bellevue, WA (US); Georg F. Petschnigg, Seattle, WA (US); Maneesh Agrawala, Berkley, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/425,343

(22) Filed: Jun. 20, 2006

(51) Int. Cl. G06F 15/00

(52) U.S. Cl. 715/500.1; 715/511

(57) ABSTRACT

Sections of two or more sequential visual media are compared to identify correspondences between the two or more sequential visual media. A visualization of section correspondences between the two or more sequential visual media is generated.

### BACKGROUND

Presentations have become a ubiquitous means of sharing information. In 2001, the Microsoft Corporation estimated that at least 30 million Microsoft PowerPoint® presentations were created every day. Knowledge workers often maintain collections of hundreds of presentations. Moreover, it is common to create multiple versions of a presentation, adapting it as necessary to the audience or to other presentation constraints. One version may be designed as a 20 minute conference presentation for researchers, while another version may be designed as an hour long class for undergraduate students. Each version contains different aspects of the content.

A common approach to building a new presentation is to study the collection of older versions and then assemble together the appropriate pieces from the collection. Similarly, when collaborating with others on creating a presentation, the collaborators will often start from a common template, then separately fill in sections on their own and finally assemble the different versions together. Yet, current presentation creation tools provide little support for working with multiple versions of a presentation simultaneously. The result is that assembling a new presentation from older versions can be very tedious.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention provide a system for comparing and managing multiple presentations. A comparison framework compares presentation slides along one or more slide features. The results of the comparison may be displayed using a visualization. Assembly tools may be used to create a new presentation using slides from existing presentations.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of an example operating environment to implement embodiments of the invention;

FIG. 2 is a flowchart showing the logic and operations of comparing and managing slide presentations in accordance with an embodiment of the invention;

FIG. 3A is a block diagram of a visual comparison window in accordance with an embodiment of the invention;

FIG. 3B is a block diagram of a presentation assembly window in accordance with an embodiment of the invention;

FIG. 3C is a block diagram of a slide preview window in accordance with an embodiment of the invention;

FIG. 4 is a flowchart showing the logic and operations of comparing presentations in accordance with an embodiment of the invention;

FIG. 5A is a block diagram of example slide features in accordance with an embodiment of the invention;

FIG. 5B is a block diagram of a bitmap slide feature in accordance with an embodiment of the invention;

FIG. 6A is a block diagram of slides in accordance with an embodiment of the invention;

FIG. 6B is a block diagram of slide correspondence in accordance with an embodiment of the invention;

FIG. 6C is a block diagram of slide correspondence in accordance with an embodiment of the invention;

FIG. 7 is a block diagram of slide correspondence in accordance with an embodiment of the invention;

FIG. 8 is a block diagram of slide correspondence in accordance with an embodiment of the invention;

FIG. 9 is a block diagram of slide correspondences in accordance with an embodiment of the invention;

FIG. 10 is a block diagram of a visualization in accordance with an embodiment of the invention;

FIG. 11 is a block diagram of a visualization in accordance with an embodiment of the invention; and

FIG. 12 is a block diagram of assembling a presentation in accordance with an embodiment of the invention.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

### 1 OPERATING ENVIRONMENT

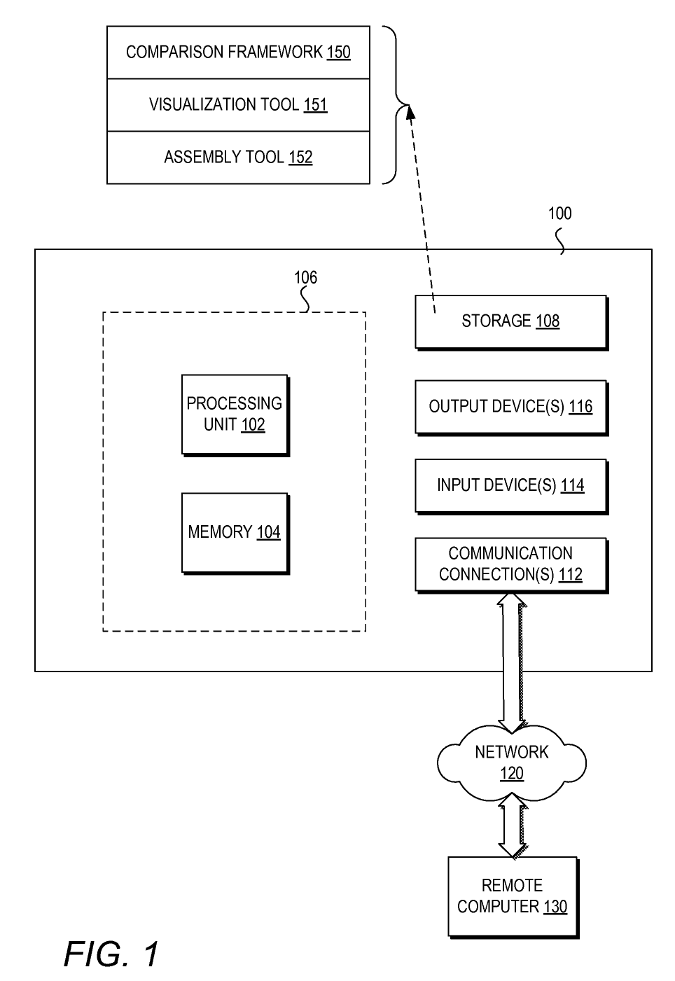

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing systems, environments, and/or configurations that may be suitable for use with embodiments described herein including, but not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, embodiments of the invention will be described in the general context of “computer readable instructions” being executed by one or more computers or other computing devices. Computer readable instructions may be distributed via computer readable media (discussed below). Computer readable instructions may be implemented as program modules, such as functions, objects, application program interfaces, data structures, and the like, that perform particular tasks or implement particular abstract data types. Typically, the functionality of the computer readable instructions may be combined or distributed as desired in various environments.

FIG. 1 shows an exemplary system for implementing one or more embodiments of the invention in a computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes both computer storage media and communication media. Computer storage media includes volatile and nonvolatile, removable and non-removable media implemented in any method or technology for storage of information such as computer readable instructions, data structures, program modules, or other data. Memory 104 and storage 108 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communication connection(s) 112 that allow the device 100 to communicate with other devices, such as with other computing devices through network 120. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may also have input device(s) 114 such as keyboard, mouse, pen, voice input device, touch input device, laser range finder, infra-red cameras, video input devices, and/or any other input device. Output device(s) 116 such as one or more displays, speakers, printers, and/or any other output device may also be included.

Those skilled in the art will realize that storage devices utilized to store computer readable instructions may be distributed across a network. For example, a remote computer 130 accessible via network 120 may store computer readable instructions to implement one or more embodiments of the invention. Computing device 100 may access remote computer 130 and download a part or all of the computer readable instructions for execution. Alternatively, computing device 100 may download pieces of the computer readable instructions as needed, or distributively process by executing some instructions at computing device 100 and some at remote computer 130 (or computer network). Those skilled in the art will also realize that by utilizing conventional techniques known to those skilled in the art, all or a portion of the computer readable instructions may be carried out by a dedicated circuit, such as a Digital Signal Processor (DSP), programmable logic array, and the like.

### 2 OVERVIEW

Embodiments described herein provide techniques and tools for visually comparing and managing multiple presentations. In one embodiment, a presentation includes a collection of slides. Such slides may be prepared and/or viewed using a presentation application, such as Microsoft PowerPoint®, Apple Keynote™, or OpenOffice Impress.

Embodiments of the invention may be applied to any sequential visual media. A sequential visual media may have multiple sections. A presentation is an example of a sequential visual media where a slide is a section. Other examples of sequential visual media include video, animation, Macromedia Flash content, a photo-story, and the like. A section may also be referred to as a frame of video. In the case of a video where frames are shown to viewers in rapid succession, the comparison framework may compare a subset of the frames from the video.

Embodiments of the invention may be implemented using one or more of the following components: a comparison framework 150, a visualization tool 151, and an assembly tool 152 in storage 108. One skilled in the art having the benefit of this description will appreciate alternative system arrangements, such as one or more components stored on remote computer 130.

Comparison framework 150 includes a framework for comparing presentations to identify the subsets of slides that are similar across each presentation and the subsets that differ. There are a number of ways to measure similarity between presentations, including pixel-level image differences between slides, differences between the text on each slide, etc. Embodiments described below include several such distance measures and discuss how they reveal the underlying similarities and differences between presentations.

Embodiments of interactive visualization tool 151 provide for viewing comparisons of multiple presentations. Users can examine the differences between presentations along any of the distance measures computed by the comparison framework. The visualization may help users understand how the presentation has evolved from version to version and determine when different portions of it crystallized into final form. Users can quickly identify sections of the presentation that changed repeatedly. Such volatility might indicate problematic areas of the presentation and can help users understand the work that went into producing the presentation.

Embodiments of interactive assembly tool 152 facilitate assembly of new presentations from the existing versions. Users can select subsets of slides from any presentation and copy them into a new presentation. The tight integration of visualization and assembly allows users to see multiple presentations and combine the most relevant parts into the new presentation. Such an assembly tool may be useful for collaborative production of presentations. Authors can independently edit the presentation and then use the assembly tool to decide which portions of each version to coalesce into the final presentation.

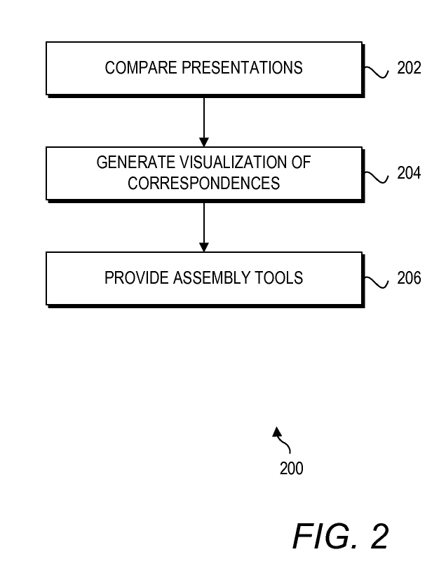

Turning to FIG. 2, a flowchart 200 shows an embodiment of the invention. Starting in block 202, two or more presentations are compared. The comparison may generate correspondences between slides of the presentations. In one example, the two or more presentations are different versions of the same presentation. In one embodiment, version relates to a date associated with a presentation, such as the last saved date. In other embodiments, version may relate to other aspects of a presentation, such as the author of the presentation. Slides of the presentations may be compared in a sequential manner, a one-to-many manner, or a many-to-many manner (discussed below).

Continuing to block 204, a visualization of the correspondences between slides of the presentations is generated and presented to a user. Next, in block 206, assembly tools are provided to a user for performing such tasks as constructing a new presentation from existing slides.

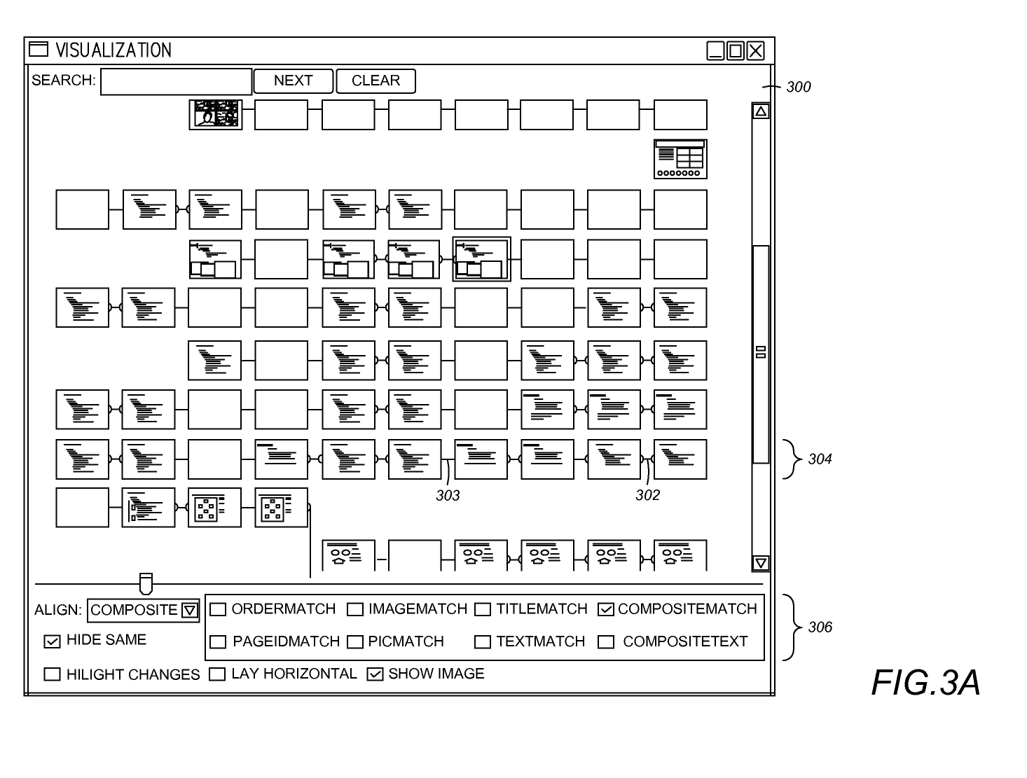

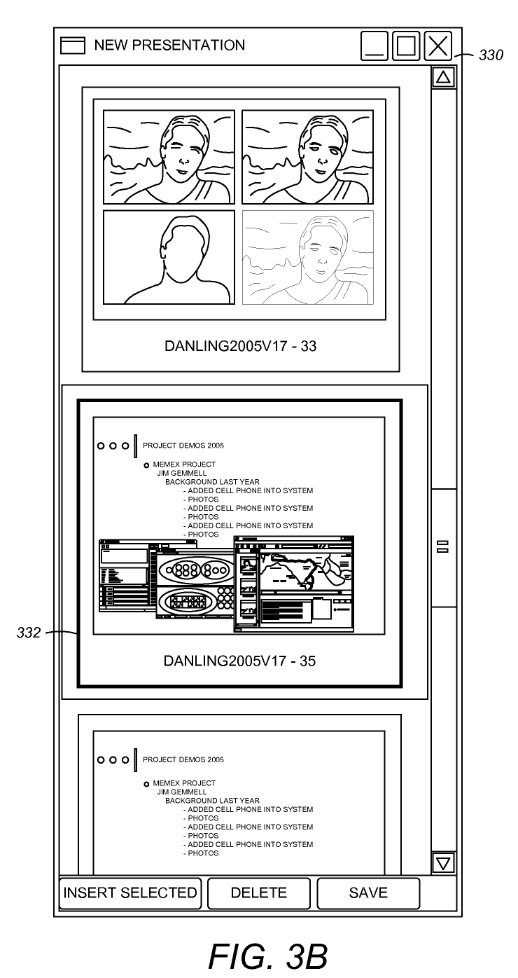

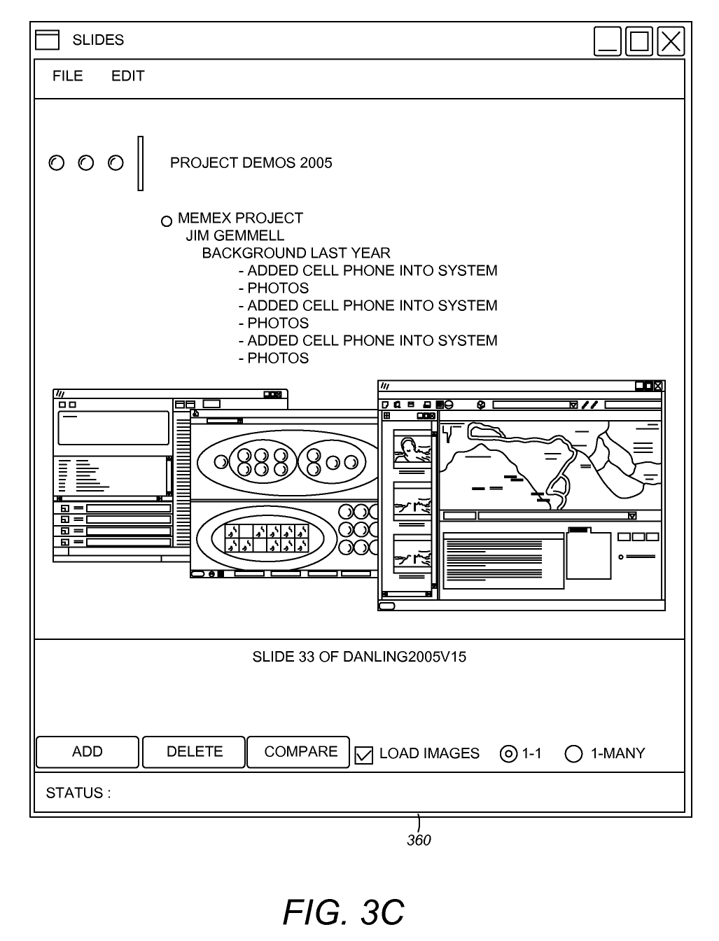

Embodiments of visualization and assembly tools are shown in the screenshots of FIGS. 3A, 3B, and 3C. FIG. 3A shows an embodiment of a visualization tool. In this example, a Visual Comparison window 300 shows 10 versions of a presentation. Each column represents a different version. Links and alignments indicate slides that are similar to one another from version to version. A link is shown by a line between slides, such as link 302. Alignment is shown by slides from different versions aligned horizontally, such as shown at 304. Embodiments of a comparison framework are discussed below in section 3 and then using the comparisons to generate visualization of multiple presentations is discussed in section 4.

Users can select any subset of slides from the Visual Comparison window 300 and copy them into an Assembly window 330 (FIG. 3B) to create a new presentation. A highlighted border, shown at 332, in Assembly window 330 indicates that several slightly different versions of the slide are available. Users can also select a single slide either in the Visual Comparison window 300 or in the Assembly window 330. A Slide Preview window 360 (FIG. 3C) allows users to inspect one slide and its alternate versions in greater detail.

### 3 COMPARISON

Comparing two presentations includes identifying similarities and differences between the slides comprising each presentation. Comparing finds for each slide in the first presentation the “best” matching slide in the second presentation based on one or more designated slide features. Moreover, the best correspondence in one feature may not be the best in another feature. Embodiments herein provide a framework for computing such correspondences with respect to a variety of features.

In the case of three or more presentations, a comparison may be done on a sequential manner, on a one-to-many manner, or a many-to-many manner. A sequential comparison includes comparing pairs of presentations of multiple presentations in a particular order. For example, given presentations A, B, C, and D, a sequential comparison compares A to B, B to C, and C to D. In a one-to-many example, the comparisons are done in relation to a single base presentation. For example, in a one-to-many comparison, where presentation A is the base, the comparisons include A to B, A to C, and A to D. In a many-to-many example, comparisons are performed between all combinations of slides. For example, a many-to-many comparison may include A to B, A to C, A to D, B to C, B to D, and C to D. While discussions below use sequential and one-to-many examples, one skilled in the art having the benefit of this description will appreciate implementations using many-to-many comparisons.

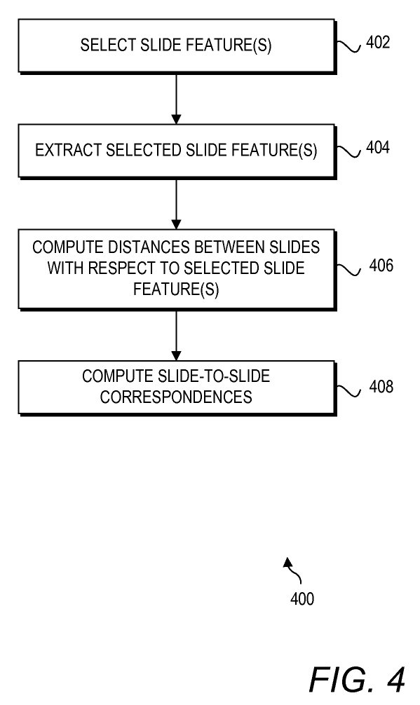

Turning to FIG. 4, a flowchart 400 shows an embodiment of comparing slides from two presentations. Staring in block 402, one or more slide features are selected. Features may be selected manually by a user, or selected using heuristics by the comparison framework (discussed below). At 306 in FIG. 3A, a user interface provides check boxes for selecting the desired slide feature for finding correspondences.

Next, in block 404, for each slide in a presentation, the selected feature(s) are extracted. Extraction may include saving a slide in a bitmap form, finding the slide identification (ID) from the object model, creating a histogram of particular slide features, and the like.

Continuing to block 406, distances between slides are computed with respect to the selected slide features. In one embodiment, feature specific distance operators are used to compute a set of distances between pairs of slides—one distance per feature type. Proceeding to block 408, slide-to-slide correspondences are computed using the slide distances. In one embodiment, correspondence operators are applied to find the “best” match between a slide in the first presentation and a slide in the second presentation.

3.1 Slide Features

A slide feature includes any descriptive element of a slide. A feature may include anything that is viewable on the slide as well as any information associated with a slide. Slide features may include vector drawings, images, charts and tables, as well as the text contained on a slide. A bitmap image of a slide may also be a feature of a slide. Other examples of slide features include the position of text boxes and graphic elements, background graphics or colors, formatting parameters of text, header text, footer text, note text, and animation settings. Other features may include audio and video embedded in a slide.

Some features are specific to the tool used to create the presentation. For example, PowerPoint® assigns a unique identification (ID) for each slide and for each image on a slide. For example lists of object model level features, see the file format specifications of Microsoft PowerPoint®, Apple Keynote™, or OpenOffice Impress.

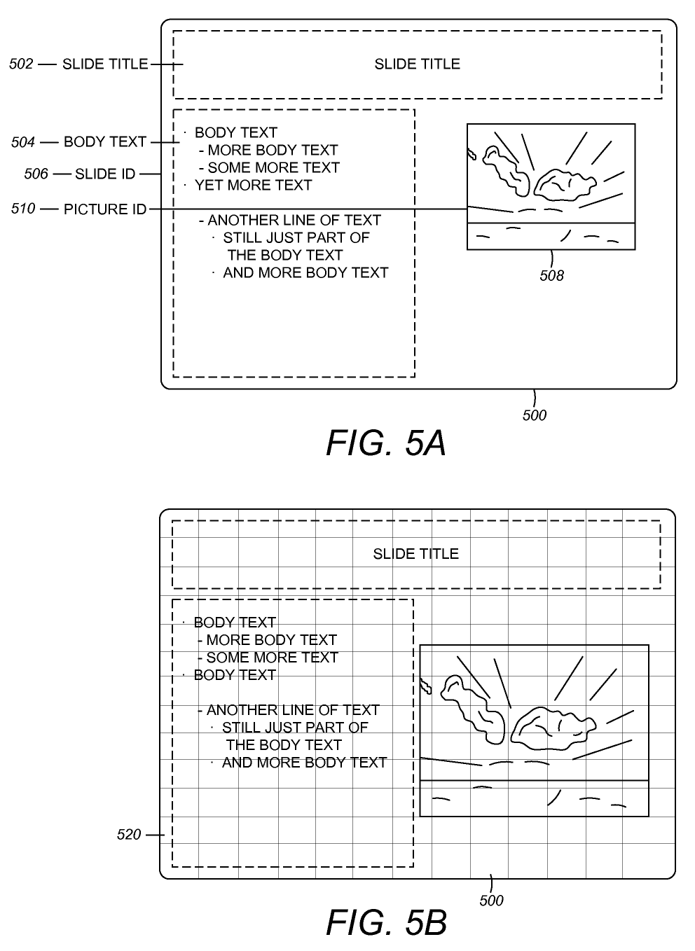

FIGS. 5A and 5B show example slide features of a slide 500. It will be understood that embodiments herein are not limited to the features shown in FIGS. 5A and 5B as the comparison framework may handle any variety of features of a slide. In FIG. 5A, features of slide 500 include slide title 502, body text 504, a slide ID 506 of slide 500, and a picture ID 510 associated with an picture 508 of slide 500.

FIG. 5B shows a bitmap 520 of slide 500. The bitmap of a slide is referred to herein as the slide image. In one embodiment, matching slides are found by hashing their respective slide images and finding exact binary matches. Non-exact matches may be found by subtracting slide images and find the magnitude of the histograms for the resulting difference image. A correspondence is based on the difference image exceeding a threshold.

3.2 Distance Operators

Distances between the slides are computed with respect to the underlying slide features. Each distance operator takes two presentations and computes a distance for each pair of slides using a selected slide feature. For example, distance operators may measure how the text and/or images differ between slides.

3.2.1 Image Based Distance

The visual distance between two slides may be computed by calculating the mean square error (MSE) between their bitmap images. The MSE measures visual similarity and a MSE of zero means that the two slides are visually identical to one another. Thus, a small MSE implies that slides are visually very similar to one another, while a large MSE implies that there may be large visual differences between the slides.

Alternate embodiments may use image comparison based on sub-region comparison of the image. In other embodiments, image distance metrics may be based on models of human visual perception.

3.2.2 Text Distance

The concept of string edit distance was first introduced by Levenshtein (see, Levenshtein, V.I., 1966, Binary codes capable of correcting deletions, insertions and reversals, Soviet Physics Doklady, pp. 707-710). The string edit distance is defined as the minimum number of operations (insertions and deletions) required to convert one string to another. File differencing programs based on edit-distance are often used by programmers to find all the lines of codes that were inserted, deleted or changed between two versions of a file. String edit distance may be used to compute distances between slides, find corresponding slides between presentations (discussed below in section 3.3), and align slides in the visualization (discussed below in section 4.1).

The string edit distance measures the minimum number of operations required to convert one string into another string. In one embodiment, a text distance operator uses Levenshtein's dynamic programming algorithm to efficiently compute the edit distance between textual features (e.g., Slide Title, Body Text). The basic algorithm is to build a matrix of costs required to convert one string into another; the costs are based on inserting a character in one sequence or in the other.

Another approach to compare text strings is based on a trigram model (see, Salton, G. and McGill, M. J., 1986, Introduction to Modern Information Retrieval, McGraw-Hill, Inc.). The idea is to build a histogram of all three letter sequences of characters within each string. The distance between the strings is then computed as the dot product of the histograms. This approach may be less sensitive than string edit distance to rearrangements of text. For example, reordering bullet points in the body text of a slide will yield a large string edit distance but a relatively low trigram distance.

3.2.3 Comparison of Slide IDs, Picture IDs

Slide IDs and Picture IDs are PowerPoint® specific features. Other presentation applications may include equivalent slide features. Slide ID and picture ID are unique identifiers for each slide and each image on a slide, respectively, and once created they remain fixed for the lifetime of a document. Thus, comparison of these IDs may be used to identify matching slides and images between two versions of a presentation. The Slide ID distance operator returns 0 if the slide IDs match and a very large value when they do not match. The Picture ID distance operator determines the maximum number of images in common between the two slides and returns the reciprocal of that number plus 1, thus slides with many matches have lower distances than those slides with fewer or no matches.

While a Slide ID distance of 0 shows that two slides once started out as identical, there is no guarantee that the slides remain similar. The slides could have been heavily edited within each presentation independently. Similarly even if slide IDs differ, the slides may be visually identical as the simple act of copy/pasting (as opposed to cut/paste) will produce identical slides with different Slide IDs. Yet the Slide ID distance does provide a notion of slide similarity that is insensitive to subsequent slide edits.

3.3 Slide Correspondence Operators

To find the best match between slides in each presentation, slide to slide correspondences are computed. These correspondences identifying the changes between presentations. As discussed below in Section 4, an interactive visualization tool is designed to visually depict these correspondences so that users can quickly see similarities and differences between multiple presentations.

Correspondence operators take two presentations as input, and yield a mapping between each slide in the first presentation and its best matching slide in the second presentation. In one embodiment, each slide can appear in at most one match, and if no good match is found the correspondence operator can leave a slide unmatched. Correspondences are computed based on the distances between slides.

3.3.1 Greedy-Thresholded Correspondence

Embodiments herein may use a greedy algorithm, which contains a threshold so that slides that are more than a minimum distance away are never matched with other slides. An embodiment of the algorithm is as follows: 1) slide distances for a feature are sorted from least to greatest, 2) for each slide in each presentation, find the slide with minimum distance subject to a minimum threshold distance, 3) create a new correspondence between these slides, 4) remove both slides from potential subsequent correspondences, 5) continue until no more correspondences can be found.

3.3.2 Composite Correspondences

Embodiments herein compute correspondences using distances from multiple slide features. It is often convenient to create correspondences from several different distances at the same time since the system can align slides on only one correspondence at a time. For example, by using both slide image and text distances in a composite correspondence, a single correspondence may be created that works well for both slides with extensive amounts of text and those with no text, but only images. In one embodiment, the different correspondences may be weighted differently in determining the composite correspondence.

In one embodiment, a composite correspondence may be created from comparing slide ID, slide image, and slide text. In one case, the strongest weighting is for slide ID, then slide image matches, and then slide text matches. Some heuristic tuning may be done when combining these different distances since the image distances are in the number of different pixels between the slide images, and the text is in the number of insertions and deletions required to convert one text string to another.

In one embodiment, the correspondence of slide image or text with the minimum distance is used (after normalizing the text and image distances). An additional slide feature, such as slide ID, may arbitrate when the other measures produce different correspondences. For example, if neither text nor image distance yield an exact match and both text and image distances result in a different correspondence, then the slide ID correspondence is used if it is the same as the text or image correspondence. If none agree (i.e., text, image, or slide ID), then no correspondence is produced.

### 4 VISUALIZATION

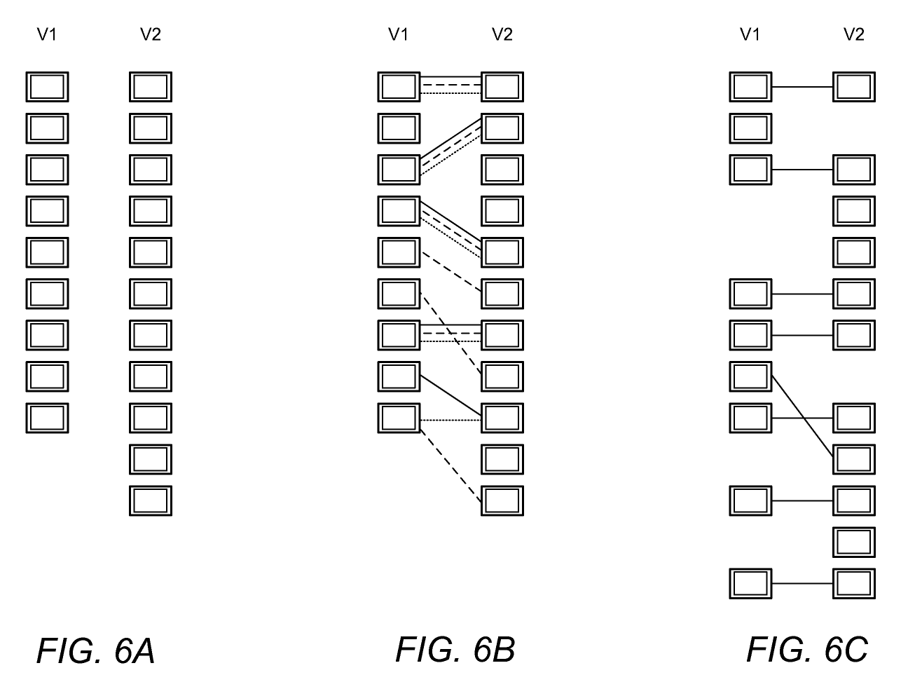

To help users understand similarities and differences in the presentations, a visualization is generated that reveals correspondences between presentations and lets users interact with it in a variety of ways. FIGS. 6A, 6B, and 6C each show two presentation versions, v1 and v2. In FIGS. 6A, 6B, and 6C, each rectangle represents a single slide and slide presentations are represented in columns. FIG. 6A shows presentations v1 and v2 without correspondence or alignment. The relative lengths of both presentations are immediately apparent.

4.1 Conveying Correspondence

Corresponding slides may be connected with links, such as lines, to convey the type of the correspondence (FIG. 6B). The lines may use color, style, such as dashed lines, and the like to indicate the type of the correspondence. For example, a green line may indicate correspondence along a first feature, and a blue line may indicate correspondence along a second feature. It is noted that the slides in FIG. 6B have not been aligned.

Corresponding slides measured along any slide feature may be aligned (FIG. 6C). The visualization computes a minimum number of gaps to maximize alignment of corresponding slides between two presentations given the constraint that each presentation must not modify the order in which the slides occur. In one embodiment, alignment may be made along a composite correspondence.

In FIG. 6C, a string alignment algorithm, based on Levenshtein, is used to compute optimal alignment. In this case, a modified Hirschberg implementation is used which uses less space then a standard Levenshtein string matching algorithm (see, Hirschberg, D. S., 1975, A linear space algorithm for computing maximal common subsequences, Communications of the ACM, 18(6), pp. 341-343). Instead of matching string characters, a match is based on the chosen correspondence function and it is used to build up a cost matrix of insertions and deletions. If two slides correspond, then a cost of 0 is added to the matrix. Otherwise, a cost of 1 is used in each of the directions indicating insertion in either sequence. After the minimum cost has been determined, this same matrix can be used to determine maximal alignment by backtracking through the matrix and following where insertions have been made.

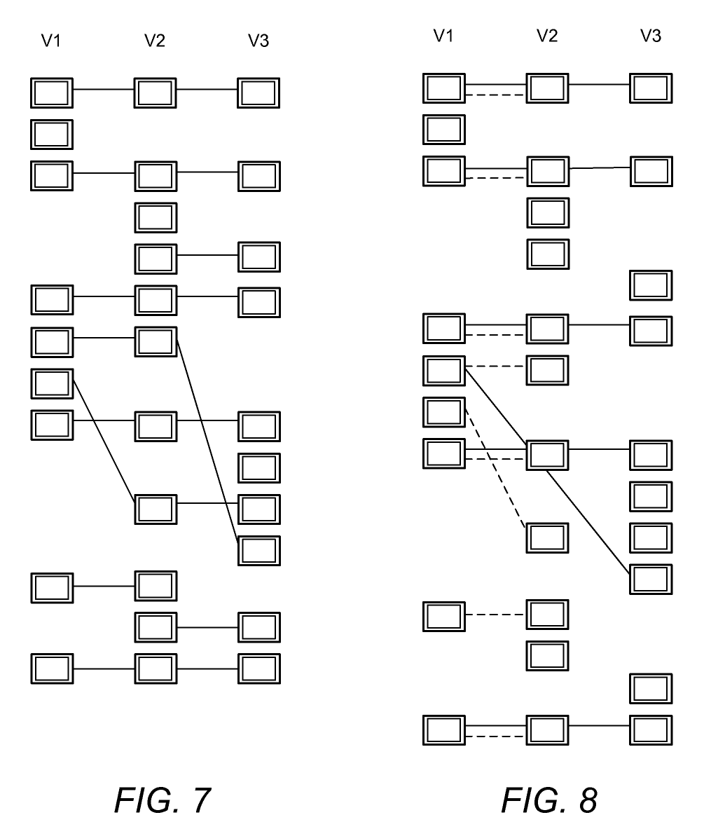

FIGS. 7 and 8 show the correspondences of three presentation versions, v1, v2, and v3. FIG. 7 shows a sequential comparison. Since FIG. 7 shows a sequential comparison, the connection lines show comparisons of v1 slides to v2 slides and v2 slides to v3 slides. It will be noted that a minimum number of gaps are inserted for alignment when comparing more than two presentations.

FIG. 8 shows a one-to-many comparison of the same presentations as FIG. 7. In this example, v1 is the base presentation. Since FIG. 8 shows a one-to-many comparison, the connection lines show comparisons of v1 slides to v2 slides by a dashed line and v1 slides to v3 slides by a solid line.

As more presentations are added to the comparison, gaps are adjusted throughout all the presentations to keep corresponding slides aligned when possible. In one embodiment, the presentations are moved through from earliest to latest version computing alignments gaps for each presentation.

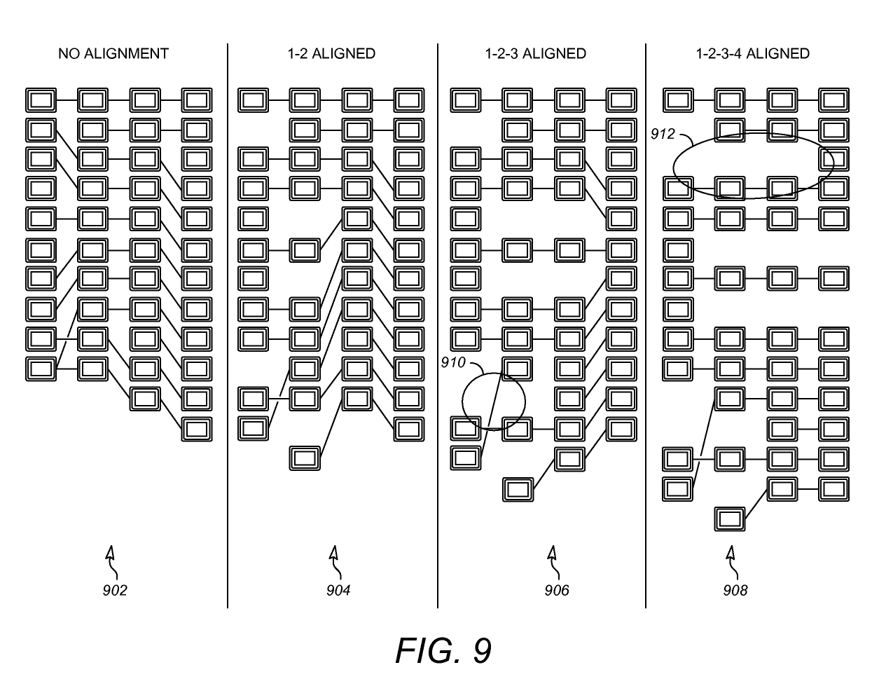

Referring to FIG. 9, four presentations are shown at various instances of alignment. At 902, correspondences are shown by links between slides, but there is not alignment. At 904, presentations 1 and 2 are aligned. At 906, presentations 1, 2, and 3 are aligned. At 908, presentations 1, 2, 3, and 4 are aligned. Gaps are inserted throughout all the already aligned presentations to keep them aligned. For example, when presentation 3 is aligned, a gap is inserted between slides in presentations 1 and 2 (indicated by ellipse 910). When presentation 4 is aligned, a gap is inserted between slides presentations 1, 2, and 3 (indicated by ellipse 912).

In one embodiment, a distinction may be made between slides that are exact matches and those that just correspond. For example, a text edit distance of 0 may indicate that slides' text correspond identically, but does not include formatting or positioning on the page.

In one embodiment, the notion of exact and inexact matches may be conveyed using indicia associated with a link between corresponding slides. In one embodiment, end caps at the end of the link are used. The end caps may use color to convey various distance measurements between corresponding slides. In one embodiment, a link with end caps conveys the visual distances between slides is perceptible by humans while a link with no end caps denotes exact matches between the slide images (i.e., the slides will be visually indistinguishable to humans). The display of end caps may be turned on and off with a button in a user interface. Also, the threshold level for the end caps between visually similar slides and visually exact slides may be adjusted by the user. In FIG. 3A, link 303 does not have end caps, but link 302 does have end caps.

In another embodiment, slides may be dimmed that do not change at all from one presentation to another to help emphasize those that do change. Examples of this can be seen in FIGS. 3A, 10 and 11 where the dimmed slides are shown as blank white slides.

4.2 Presentation to Presentation Visualizations

Sequential comparisons are useful for tracking changes on a single presentation over multiple versions. Some slides have no correspondences between next or previous presentations (for example, because they have been newly introduced in a subsequent presentation, deleted from a previous presentation, or modified enough that no corresponding slide can be found). This is shown in the visualization as a single slide at the beginning (for newly introduced slides) or end of a row (for deleted slides). Slides that have been moved across stable boundaries (i.e., large sequences of corresponding slides) cannot be aligned, but are still connected by corresponding links.

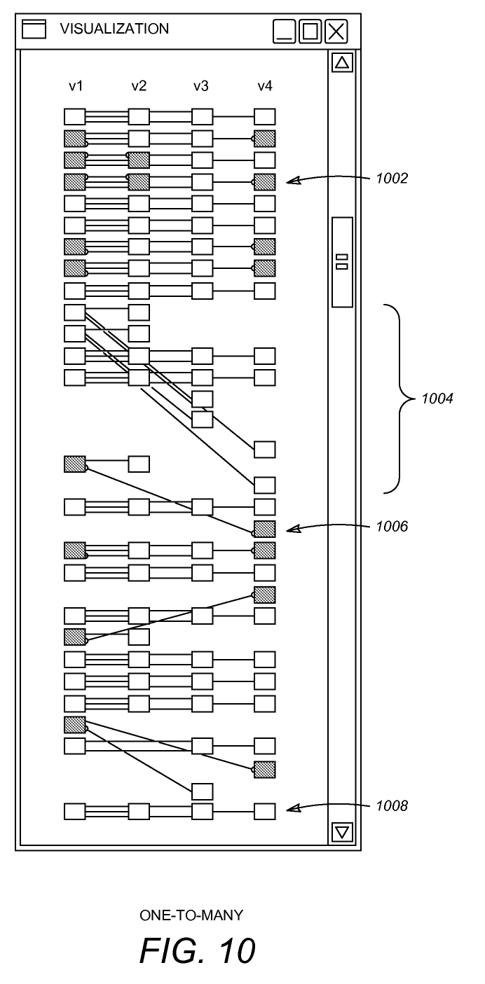

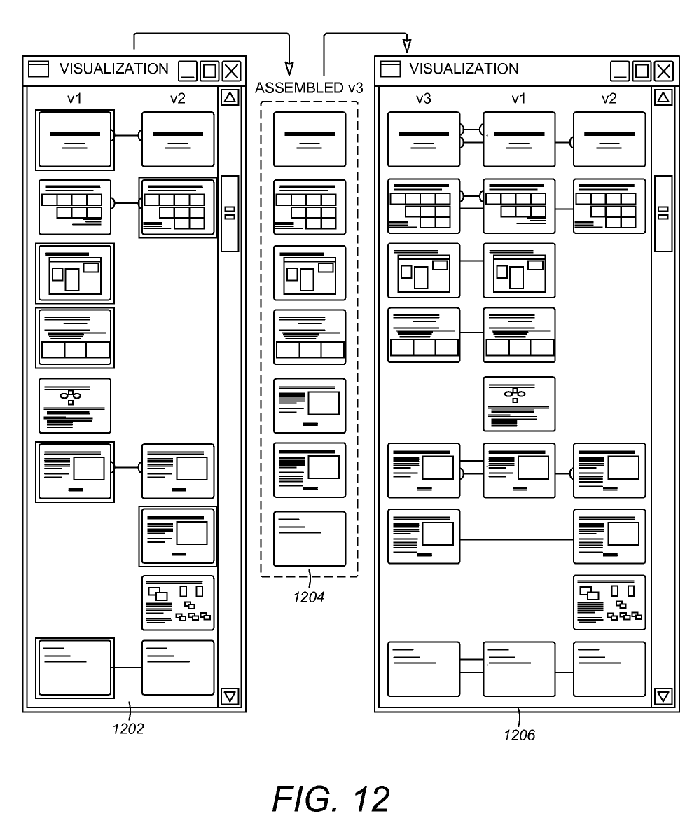

The one-to-many comparisons may be useful in examining differences between one base presentation and alternative versions. In some cases, the base version has been used to assembly new presentations or, in other cases, multiple collaborators are simultaneously working on alternate presentations. Each slide is connected (and potentially aligned with) a corresponding slide in the first presentation. Examples of one-to-many comparisons are discussed in connection with FIGS. 10 and 12.

4.3 Interacting With the Visualization

The user can interact with the visualization by using a slider to zoom out to see an overview of the changes, or to zoom into a particular slide or region of slides. Clicking on a slide may select it and bring up a full resolution slide in a slide preview window. The user can use the arrow keys on the keyboard to move the selection forward or backward within a presentation, or move between corresponding slides within presentations.

In one embodiment, change blindness may be exploited to find visual differences between slides. Change blindness refers to the notion that some visual changes between slides are not perceived by humans. Techniques may be employed to avoid change blindness and make subtle visual changes obvious to a human. For example, a visualization user interface allows a user to toggle between two different slides. By quickly moving back and forth between corresponding slides, the user can easily perceive visual differences in the slides using the preview window.

Checkboxes allow different correspondence links to be turned on and off, and a pull down menu allows the presentations to be aligned along any of the correspondences. Images of slides can be turned on or off to just focus on the overall structure of changes. The user can also changed the layout to horizontal or vertical depending on the preferred mode of operation.

### 5 ASSEMBLY

An assembly tool facilitates the assembly of new presentations. These tools support common usage patterns among presenters. Users often pull from a large number of related presentations in the creation of a new presentation. They also often work with collaborators and may need to examine and incorporate differences into a single presentation.

Users can select slides from the visualization in a number of ways: individual slides can be selected by clicking on the slides themselves, all the slides within a presentation may be selected by clicking on the presentation title, all slides that have a particular term may be selected by searching for them, and all changed slides may be selected using a button in the interface. Users may also move to the next change (as indicated, for example, by a slide with no correspondence or a corresponding slide with visual differences) detected in any presentation.

Selected slides can then be inserted into a newly created presentation at the current selection point. Slides can be rearranged within the new presentation via drag and drop or standard cut and paste. The slides also still maintain their correspondences to slides in the other presentations, and the user can easily choose with the arrow keys between alternate slides (relative to different correspondences) in the newly created presentation. Slides that have visually distinguishable correspondences may be highlighted, such as by a colored border, to indicate that alternate slides are available.

Strategies for assembling presentations may include starting with all the slides in the first version, copying them into the new presentation and then deciding which changed slides to use. Alternatively, the user can start with a final version and choose which changes to roll back. The user can also choose individual slides or slide ranges from the existing presentations and insert them into the newly created presentation. Users can then save the new presentation and edit it within PowerPoint® or some other slide creation program.

Embodiments herein may be used to track and manage presentations across an entity, such as a corporation. For example, presentations across a corporate network, such as network 120, may be compared and the results presented in a visualization, such as on a display of computing device 100. The presentations may have been created by various users. It may be discovered that groups that do not normally work together actually use similar slides in their respective presentations. In one implementation, comparison framework 150 and visualization tool 151 may execute on a server to analyze a corporate repository of slides, such as Microsoft SharePoint®.

Also, embodiments herein may allow presentations on similar topics to be clustered and made available as a presentation warehouse for future use. For example, all finance related presentations may be clustered. A new finance related presentation may be built from this cluster (saving time) and this new presentation added to the cluster. In another example, clustering presentations may give a corporation a historical record of presentations. This enables the corporation to evaluate which topics routinely appear in presentations, and thus, are routinely issues of discussion for the corporation.

### 6 EXAMPLES

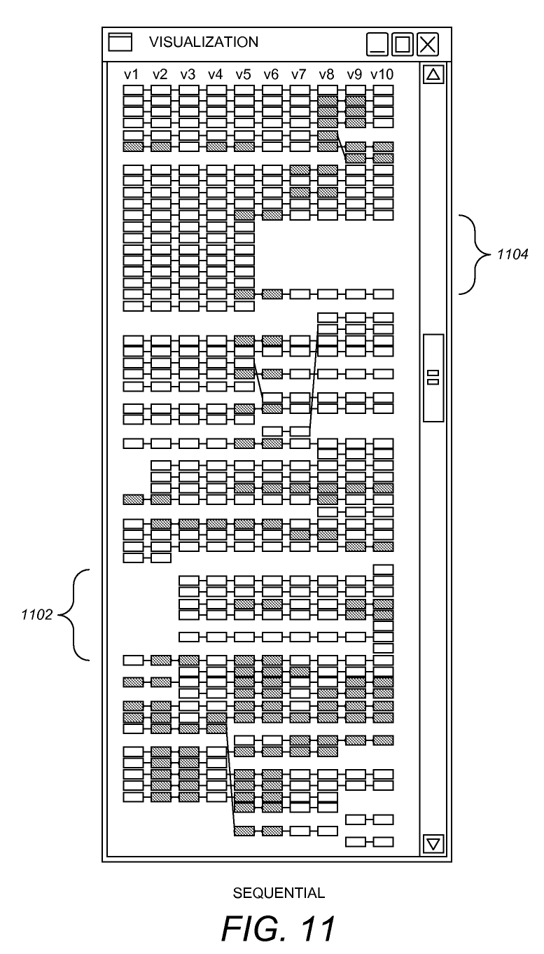

Examples of embodiments of the invention are shown in FIGS. 10, 11, and 12. In FIGS. 10 and 11, slides without changes are dimmed (shown as blank slides) while slides with changes are shaded grey. FIG. 10 shows a one-to-many comparison where several authors edited a single base presentation v1. The system is used to identify and to coalesce changes. FIG. 10 shows when authors spot the same typo or how different authors might suggest alternate changes to the flow of the presentation. For example, at 1002, authors of v2 and v4 have found the same typo that is in v1. The 4^{th} slide in v1, v2, and v4 are highlighted since a comparison of v1 to v2 and v1 to v4 indicate correspondence without an exact match. At 1004, authors of v3 and v4 have moved slides to different locations without making changes to the slides. At 1006, author of v4 has moved and revised slides as compared to v1. It is noted that contact slides at the end of the presentation, shown at 1008, did not change between versions.

FIG. 11 shows a visualization of a sequential comparison of 10 different versions of a presentation prepared by multiple authors for an executive review. The visualization totals 497 slides. In this view, identical slides have been dimmed to draw attention to 112 slides that have been edited. Each version of the presentation is sequentially compared to the next which allows for an analysis of the presentation over time.

The visualization in FIG. 11 provides various pieces of information. In version 3, several slides have been added as indicated by the large insertion gaps (shown at 1102). Conversely from version 5 to version 6, a six slide section was removed to shorten the presentation (shown at 1104). Slide changes occur all the way to the end, across the entire presentation reflecting modifications introduced after rehearsing the presentations.

FIG. 12 depicts an example of presentation assembly. Here a researcher prepares for a mid year review by pulling slides from two research talks given earlier in the year, presentations v1 and v2, shown in window 1202. In window 1202, v1 and v2 are aligned using a slide image correspondence. Correspondence lines without end caps indicate an exact match, while correspondence lines with end caps indicate corresponding slides with changes between slides.

The visualization lets the researcher compare the two presentations and choose the desired slides (shown as v3 at 1204). For example, the second slide in the assembly v3 is from v2, the fifth slide is from v1. Additionally, the alignment gaps in window 1202 show which slides only exist in one version. Once the assembly step is complete, the researcher can save out a new version of the presentation and make modifications such as updating the title slide.

Window 1206 uses a one-to-many correspondence with the new presentation v3 as the base presentation. The newly assembled presentation v3 is compared to its sources v1 and v2. This view shows from which presentation slides were taken. Correspondence lines between slides without end caps indicate an identical image match. In this view the researcher can still swap out slides with their alternate versions.

Embodiments of the invention include a comparison framework and tools for analyzing and managing multiple presentations. These tools can be used in the creation of new presentations and support a variety of work strategies from tracking changes for individuals, merging multiple versions, or discovering similar presentations across a corporate network.

Various operations of embodiments of the present invention are described herein. In one embodiment, one or more of the operations described may constitute computer readable instructions stored on computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
comparing sections of two or more sequential visual media to identify correspondences between the two or more sequential visual media; and
generating a visualization of section correspondences between the two or more sequential visual media.

2. The method of claim 1 wherein comparing two or more sequential visual media includes:
computing distances between the sections with respect to one or more section features; and
computing correspondences between the sections using the computed distances.

3. The method of claim 2 wherein computing distances includes computing a composite correspondence, wherein the composite correspondence is a correspondence relating to two or more section features.

4. The method of claim 2 the section features includes one or more of text, image, or section identification (ID).

5. The method of claim 1 wherein comparing sections of two or more sequential visual media includes comparing the sections in a sequential manner.

6. The method of claim 1 wherein comparing sections of two or more sequential visual media includes comparing the sections in a one-to-many manner.

7. The method of claim 1 wherein comparing sections of two or more sequential visual media includes comparing the sections in a many-to-many manner.

8. The method of claim 1 wherein generating the visualization includes:
showing a correspondence between two sections with respect to a section feature using a link between the two sections; and
aligning sections that correspond along the section feature.

9. The method of claim 1, further comprising assembling a new sequential visual media from the visualization.

10. The method of claim 1 wherein the two or more sequential visual media are stored on a corporate network.

11. One or more computer readable media including computer readable instructions that, when executed, perform the method of claim 1.

12. A method, comprising:
extracting one or more slide features from slides of two or more presentations;
computing distances between the slides with respect to one or more slide features; and
computing slide-to-slide correspondences between the slides based on the computed distances.

13. The method of claim 12 wherein computing distances includes computing the distance between a first slide and a second slide by computing the mean square error between the bitmap images of the first slide and the second slide.

14. The method of claim 12 wherein computing distances includes computing the string edit distance between a first slide and a second slide, wherein the string edit distance measures the minimum number of operations to convert one string from the first slide into a string of the second slide.

15. The method of claim 12 wherein computing distances includes comparing a slide identification and a picture identification associated with a first slide to a slide identification and a picture identification associated with a second slide.

16. The method of claim 12 wherein computing slide-to-slide correspondences includes using a greedy-thresholded correspondence, wherein the greedy-thresholded correspondence includes matching slides that are within a minimum distance from each other.

17. The method of claim 12 wherein computing slide-to-slide correspondences includes using a composite correspondence, wherein the composite correspondence is a correspondence associated with two or more slide features.

18. A system, comprising:
a comparison framework to compare two or more presentations to identify slides of the two or more presentations that are similar;
a visualization tool to generate a visualization of correspondences between similar slides of the two or more presentations; and
an assembly tool to facilitate assembly of a new presentation from the two or more presentations.

19. The system of claim 18 wherein to compare the two or more presentations includes:
computing distances between the slides with respect to one or more slide features; and
computing slide-to-slide correspondences between the slides based on the computed distances.

20. The system of claim 18 wherein to generate the visualization includes:
showing correspondences between slides based on one or more slide features using links, wherein the links include indicia showing an exact match or a similar match between corresponding slides; and
aligning corresponding slides along one of the slide features.
